(19) United States
(12) Patent Application Publication
(10) Pub. No.: US 2021/0328478 A1
(43) Pub. Date: Oct. 21, 2021

(54) Electric Dispensing Tool Motor

(71) Applicant: Larry Childs, Cotati, CA (US)

(72) Inventor: Larry Childs, Cotati, CA (US)

(21) Appl. No.: 17/362,441

(22) Filed: Jun. 29, 2021

(51) Int. Cl. H02K 7/00; H02K 7/116; H02K 5/16; F16H 1/32

(52) U.S. Cl. CPC H02K 7/003; F16H 1/32; H02K 5/161; H02K 7/116

(57) ABSTRACT

A brushless DC power tool motor comprises an integrated planetary gear set with a drive drain well suited to create thrust for use in powered caulking dispensers. Disclosed embodiments may comprise a shaft disposed through the center of the motor. The shaft has an acme thread on the exterior with two flats ground on it on opposing sides used to keep the motor shaft from turning. The motor windings are driven with a 12 power transistor control board allowing the motor to be driven in delta or Y configuration, with a “low speed, high torque” mode and a “high speed low torque” mode. The motor controller may determine the mode for the required torque and speed being demanded by the operator.

### COPYRIGHT AND TRADEMARK NOTICE

This application includes material which is subject or may be subject to copyright and/or trademark protection. The copyright and trademark owner(s) has no objection to the facsimile reproduction by any of the patent disclosure, as it appears in the Patent and Trademark Office files or records, but otherwise reserves all copyright and trademark rights whatsoever.

### BACKGROUND OF THE INVENTION

### (1) Field of the Invention

The invention generally relates to electric motor systems used in dispensing systems. More particularly, the invention relates to means and methods of creating a motor system well suited for the propulsion of fluids of high viscosity, such as caulk.

### (2) Description of the Related Art

The known related art fails to anticipate or disclose the principles of the present invention. In the prior art tool speed changes are often changed with the inefficient use of high/low gear changes. Such system of the prior art are inefficient in the use of materials and in the use of space to multiple sets of gears. Competing motor systems of the prior art are often burdened with bulky form factors and the use of a clutch or breakaway device.

Thus, there is a need in the art for the present invention.

### BRIEF SUMMARY OF THE INVENTION

The present invention overcomes shortfalls in the related art by presenting an unobvious and unique combination and configuration of methods and components to create a brushless direct current power tool motor with variable rotational speeds with the motor system eschewing the high/low gear changes of the prior art.

The invention overcomes shortfalls in the related art by avoiding the use of a clutch or a breakaway device but while maintaining a compact form factor not found in the related art.

Presently disclosed embodiments overcome shortfalls in the related art by employing new design concepts for a brushless direct current power tool motor with an integrated planetary gear set using new design concepts for a brushless DC power tool motor with integrated planetary gear set. A new drive drain system is used propel or create thrust for use in powered caulking dispensers or other dispensing systems.

Embodiments of the invention may also include:

A rotational shaft axially disposed through the center of the motor. The shaft has an acme thread on the exterior with two flats ground on it on opposing sides used to keep the motor shaft from rotating.

The planet gear carrier has the matching acme thread cut on its interior. The motor core has the sun gear for the planetary gear set made on its hollow shaft. The outer ring gear for the planetary gears is stationary and serves as one of the guides to keep the shaft from rotating (having two flats matching the flats on the shaft)

The planet carrier is constrained with roller thrust bearings in both directions and otherwise floats radially in the gear set maintaining perfect gear mesh under load.

Further aspects of the disclosed embodiments include:

The motor windings are two stage, with a “low speed, high torque” winding and a “high speed, low torque” winding. The motor controller will determine the winding used or combination of windings used for the required torque and speed being demanded by the operator. The innovative use of a dual winding eliminates the high/low gear change requirement to have a tool with very high torque and high speed. This feature is also applicable and useful to hand held drills that currently need a high/low gear selector to cover the operating range.

These and other objects and advantages will be made apparent when considering the following detailed specification when taken in conjunction with the drawings.

### BRIEF DESCRIPTION OF THE DRAWINGS

FIG. 1 depicts a side view of a motor

FIG. 2 depicts a sectional side view of a motor

FIG. 3 depicts an end view of a motor

FIG. 4 depicts an exploded view of a motor

FIG. 5 depicts several views of a planet carrier with an internal acme thread

FIG. 6 depicts several views of a nose guide

FIG. 7 depicts various components of a motor core with magnets

### REFERENCE NUMERALS IN THE DRAWINGS

100 a disclosed electric dispensing tool motor
105 rear housing guide
107 rear housing guide bushing
110 acme shaft with two flats
112 high speed low torque winding
113 low speed high torque winding
120 motor core with magnets
125 center plate
130 sun gear
140 rear thrust bearing assembly
160 planet gear shafts
165 planet gears
170 planet carrier
173 internal acme thread of planet carrier
180 forward thrust bearing assembly
190 nose guide
195 planet ring gear of nose guide 190
197 flats void defined within nose guide 190

### DETAILED DESCRIPTION OF EMBODIMENTS OF THE INVENTION

The following detailed description is directed to certain specific embodiments of the invention. However, the invention can be embodied in a multitude of different ways as defined and covered by the claims and their equivalents. In this description, reference is made to the drawings wherein like parts are designated with like numerals throughout.

Unless otherwise noted in this specification or in the claims, all of the terms used in the specification and the claims will have the meanings normally ascribed to these terms by workers in the art.

Unless the context clearly requires otherwise, throughout the description and the claims, the words “comprise,” “comprising” and the like are to be construed in an inclusive sense as opposed to an exclusive or exhaustive sense; that is to say, in a sense of “including, but not limited to.” Words using the singular or plural number also include the plural or singular number, respectively. Additionally, the words “herein,” “above,” “below,” and words of similar import, when used in this application, shall refer to this application as a whole and not to any particular portions of this application.

The above detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while steps are presented in a given order, alternative embodiments may perform routines having steps in a different order. The teachings of the invention provided herein can be applied to other systems, not only the systems described herein. The various embodiments described herein can be combined to provide further embodiments. These and other changes can be made to the invention in light of the detailed description.

Any and all the above references and U.S. patents and applications are incorporated herein by reference. Aspects of the invention can be modified, if necessary, to employ the systems, functions and concepts of the various patents and applications described above to provide yet further embodiments of the invention.

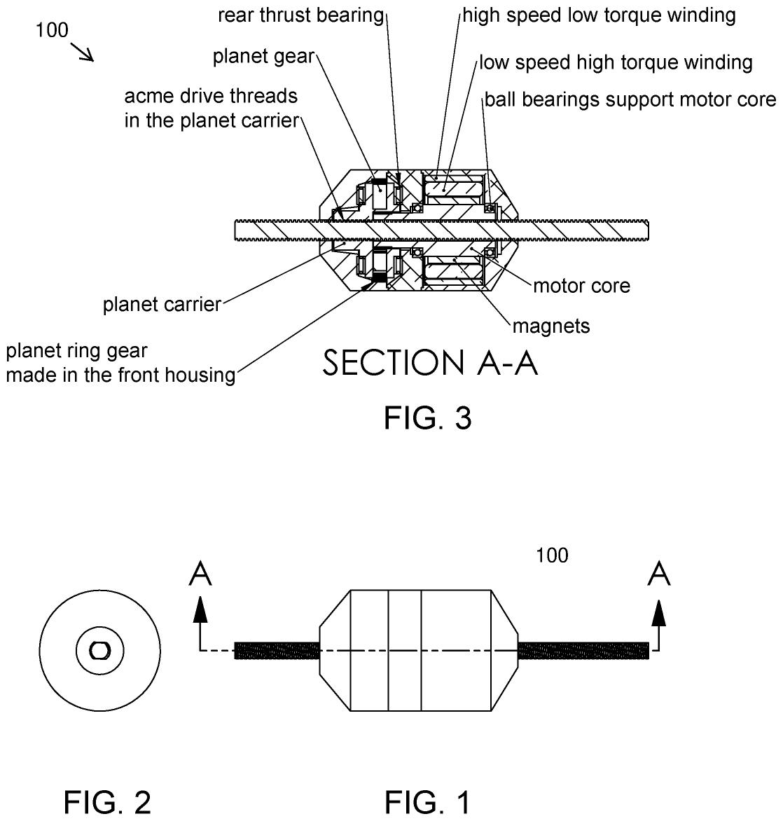

FIG. 1 depicts an external side view of a disclosed motor system 100.

FIG. 2 depicts an end view of a disclosed motor system.

FIG. 3 depicts a sectional view of FIG. 1 and discloses various internal components such as a planet carrier, planet ring hear disposed in the front housing, high speed low torque winding ow speed high torque winding, ball bearings support for motor core and other components.

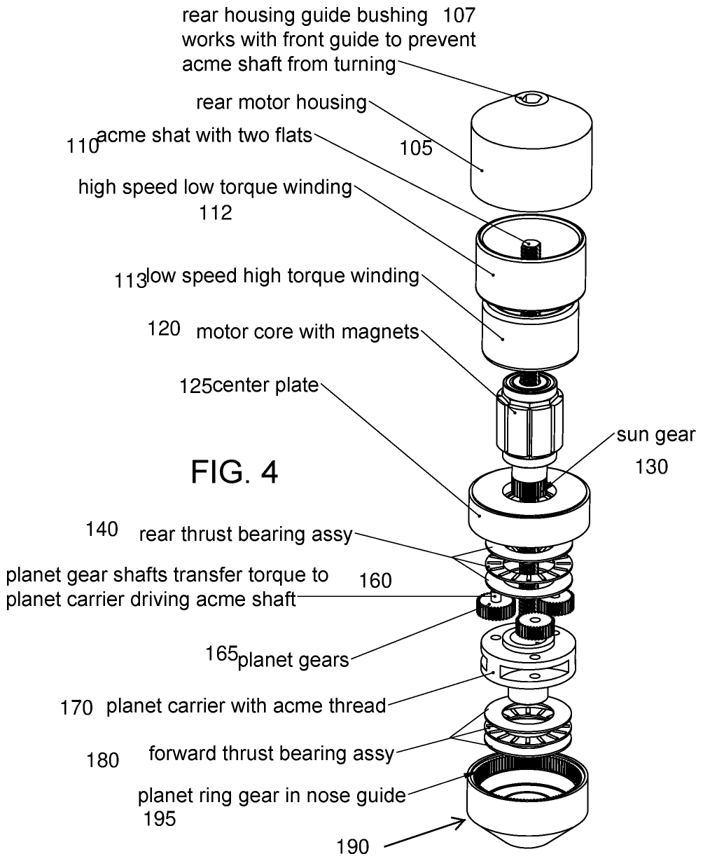

FIG. 4 depicts an exploded view of a disclosed embodiment.

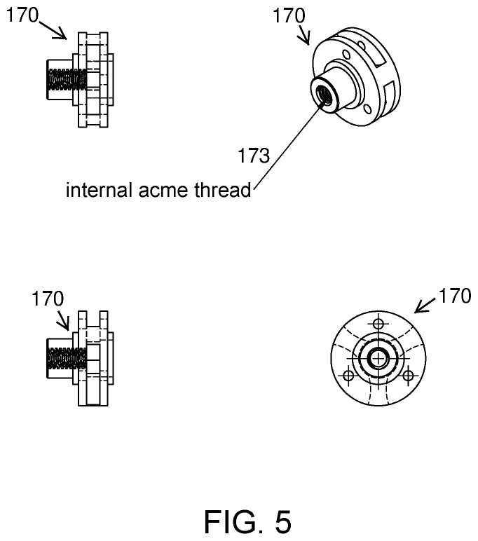

FIG. 5 depicts various views of a disclosed planet carrier 170 with the planet carrier having internal acme threading 173.

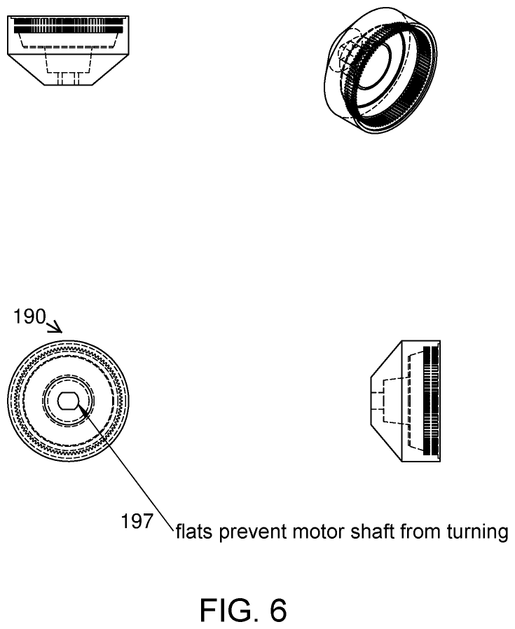

FIG. 6 depicts a nose guide 190 with the nose guide defining a flat void 197. The flat void of flats used to prevent the motor shaft from turning.

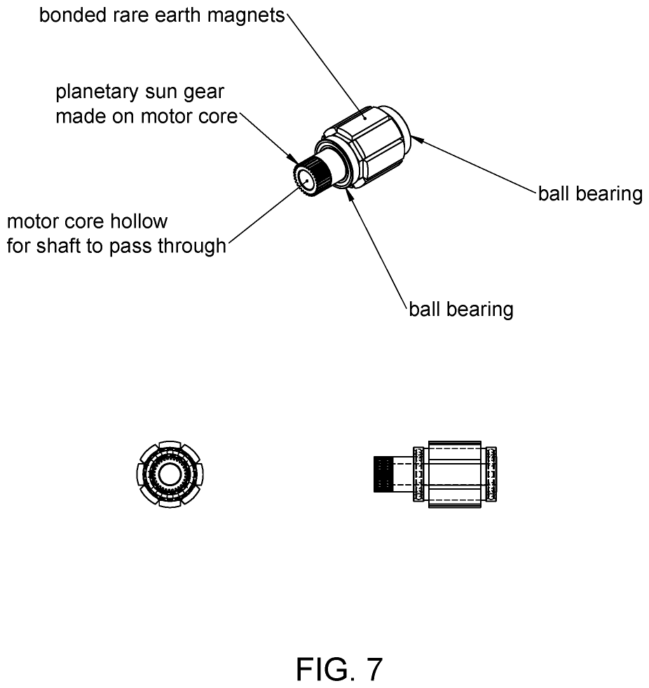

FIG. 7 depicts various views of a motor core with magnet assembly, which may include bonded rare earth magnets, planetary sun gear disposed upon the motor core, a motor core hollow void to accept the shaft, ball bearings and other components.

Disclosed embodiments are well suited for a brushless DC power tool motor with integrated planetary gear set. Disclosed drive trains are very useful to create thrust for use in powered caulking dispensers.

Further features that overcome shortfalls in the prior art include:

Shaft going through the center of the motor. The shaft has an acme thread on the exterior with two flats ground on it on opposing sides used to keep the motor shaft from turning.

The planet carrier is constrained with roller thrust bearings in both directions and otherwise floats radially in the gear set maintaining perfect gear mesh under load.

Features that apply to other power tools as well:

The motor windings are driven with a 12 power transistor control board allowing the motor to be driven in delta or Y configuration, with a “low speed, high torque” mode and a “high speed low torque” mode. The motor controller will determine the mode for the required torque and speed being demanded by the operator. The innovative use of a dual drive control board eliminates the high/low gear change requirement to have a tool with very high torque and high speed. This feature will also apply to handheld drills that currently need a high/low gear selector to cover the operating range.

What is claimed is:

1. A brushless DC motor comprising:
a) a rear housing guide bushing defined within a rear motor housing;
b) an acme shaft having a distal end, with the distal end having two flat surfaces and the two flat surfaces disposed within the rear housing guide bushing so as to prevent the acme shaft from rotating;
c) a torque winding concentrically disposed within the rear motor housing;
d) a motor core with magnets concentrically disposed within the torque winding;
e) a sun gear disposed upon a lower end of the motor core;
f) the sun gear in geared connection to a center plate;
g) a rear thrust bearing assembly concentrically disposed within the center plate;
h) a plurality of planet gears with each planet gear having a shaft and the plurality of planet gears in geared connection to the acme shaft;
i) a planet carrier defining an acme thread, the planet carrier defining an inner void, with the acme shaft disposed within the inner void, the planet carrier further defining circumference voids retaining the planet gear shafts;
j) a forward thrust bearing assembly concentrically disposed within a lower protrusion of the planet carrier;
k) a planet ring nose guide retaining the planet carrier.
